(19) United States
(12) Patent Application Publication
(10) Pub. No.: US 2014/0372031 A1
(43) Pub. Date: Dec. 18, 2014

(54) SYSTEMS, METHODS AND COMPUTER-READABLE MEDIA FOR GENERATING DIGITAL WAYFINDING MAPS

(71) Applicant: Rivendell Technologies, LLC, Altoona, PA (US)

(72) Inventors: Ethan Canner, Philipsburgh, PA (US); Jonathan McKnight, Morrisdale, PA (US)

(21) Appl. No.: 13/919,660

(22) Filed: Jun. 17, 2013

(51) Int. Cl. G01C 21/20

(52) U.S. Cl. CPC G01C 21/206
USPC 701/533

(57) ABSTRACT

Systems, methods and computer-readable storage media for generating digital wayfinding maps are described. A system for generating digital wayfinding maps may be configured to receive lines representing paths between points of interest on a map unit. For example, a developer may draw a lines on a map unit using an input device, such as a mouse. The system may automatically generate nodes at the ends of each line and at any point where lines intersect. The lines may be divided such that each pair of nodes is connected by one individual line. The nodes and lines connecting the nodes may be used to generate routes between the nodes to provide users with directions between nodes.

### BACKGROUND

Digital mapping technology is a useful tool used by many people every day. Individuals now rely on digital map applications to provide turn-by-turn or step-by-step directions when traveling from one location to another. However, despite advances in computing technology, the creation of digital maps remains a manual and labor intensive process. Although a digital map may be initiated using electronic files, such as an image of a map, a digital picture, or digital blueprints, the process requires that each point of interest and each path connecting the points of interest be input manually into the digital map. This process can be very time consuming because all of the various permutations between different points of interest must be charted on the digital map and/or entered into a map database. This is especially true for indoor maps of buildings, which typically must be created individually with the involvement of the owner of the building. It will therefore be desirable to generate a digital map using a process configured to minimize the number of developer input events required to map and connect all of the points of interest of a geographic area and/or building represented by the digital map.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a system for generating routes for a digital wayfinding map may comprise a processor and a non-transitory, computer-readable storage medium in operable communication with the processor. The computer-readable storage medium may contain one or more programming instructions that, when executed, cause the processor to receive a plurality of lines arranged on a map unit of the digital wayfinding map, the plurality of lines comprising a first end and a second end. The one or more programming instructions, when executed, may further cause the processor to generate a plurality of nodes on the map unit responsive to receiving each of the plurality of lines, the plurality of lines forming paths between the plurality of nodes, and position the plurality of nodes at the first end, the second end, and at least one intersection point created responsive to intersection of the plurality of lines.

In an embodiment, a computer-implemented method for generating routes for a digital wayfinding map, by a processor, may comprise receiving a plurality of lines arranged on a map unit of the digital wayfinding map, the plurality of lines comprising a first end and a second end, and generating a plurality of nodes on the map unit responsive to receiving each of the plurality of lines, the plurality of lines forming paths between the plurality of nodes. The plurality of nodes may be positioned at the first end, the second end, and at least one intersection point created responsive to intersection of the plurality of lines.

In an embodiment, a computer-readable storage medium having computer-readable program code configured to generate routes for a digital wayfinding map embodied therewith, the computer-readable program code may comprise computer-readable program code configured to receive a plurality of lines arranged on a map unit of the digital wayfinding map, the plurality of lines comprising a first end and a second end. Computer-readable program code may be configured to generate a plurality of nodes on the map unit responsive to receiving each of the plurality of lines, the plurality of lines forming paths between the plurality of nodes. Computer-readable program code may be configured to position the plurality of nodes at the first end, the second end, and at least one intersection point created responsive to intersection of the plurality of lines.

### BRIEF DESCRIPTION OF THE DRAWINGS

The above and other objects of the present invention will become more readily apparent from the following detailed description taken in connection with the accompanying drawings.

FIG. 1 depicts an illustrative digital wayfinding map according to some embodiments.

FIG. 2 depicts a digital wayfinding map system according to some embodiments.

FIGS. 3A-3G depict an illustrative example of generating a portion of a digital wayfinding map according to some embodiments.

FIG. 4 depicts a flow diagram for an illustrative method for generating a digital wayfinding map according to some embodiments.

FIG. 5 illustrates various embodiments of a computing device for implementing the various methods and processes described herein.

### DETAILED DESCRIPTION

The described technology is directed to systems, methods and computer-readable storage media for generating digital wayfinding maps and routes between points associated therewith. In general, a digital wayfinding map may include a graphical representation of an area, such as a geographic location and/or a structure, and routes for navigating between points within the area. For example, a digital wayfinding map may be configured to represent a city and may include routes for traveling between locations in the city, such as buildings, addresses and streets. In another example, a digital wayfinding map may represent an indoor space, such as the interior of a building, and may include routes for navigating between rooms, floors, entrances, doorways, elevators, stairs, or other points of interest within the building. Non-limiting examples of buildings include hospitals, office buildings, school buildings, convention centers, sports stadiums and arenas, hotels, manufacturing facilities, and shopping centers. In a further example, a digital wayfinding map may be configured to represent both indoor and outdoor spaces, such as a college campus, a medical campus, an amusement park, a zoo, a public transportation system, or a geographical area including buildings. For example, a digital wayfinding map may be configured to provide directions from a room in a first building, to a room in a second building via an outdoor path.

According to some embodiments, a digital wayfinding map may be accessible through a map application executed by a logic device, such as a server, personal computer (PC), tablet computing device, kiosk computing system, smartphone, or the like. The map application may be configured to manage various information elements, including, without limitation, files, data, route generation processes, and/or user input associated with the digital wayfinding map. A user may access the digital wayfinding map through a display component in operable communication with the logic device executing the map application. For example, the map application may be configured to render an image of an area on the display component and to access a database including digital signage locations and/or points of interest for display on the image. The map application may receive user input indicating a starting point and a destination point and may generate a lowest-cost route (for example, the “best” route based on various criteria and/or factors) for display on the image of the area. For instance, kiosk computing devices may be located at the entrances of a hospital. A user may select a destination, such as a diagnostic imaging center, from the kiosk computing devices at the particular entrance to receive directions to the destination.

A digital wayfinding map may include, without limitation, one or more map units, nodes arranged within the one or more map units, lines connecting the nodes, routes between the nodes, and processes for determining the lowest-cost route from a starting point to a destination point. In an embodiment, a map unit may include an individual graphical representation within the digital wayfinding map. A non-limiting example of a map unit may include a geographical location, a structure, an object, or portions thereof. For instance, a digital wayfinding map may be configured for a building and may include a map unit for each floor and a map unit representing the area immediately surrounding the building, such as the parking area for the building. In another instance, a digital wayfinding map may be configured for a geographical region and may include map units representing a certain defined area of the geographical region, such as square area units (for example, “tiles”) or defined sub-regions (for example, a city, a suburb, a university campus, or the like).

The nodes may be configured to represent points of interest within the digital wayfinding map, such as countries, states, cities, towns, streets, addresses, buildings, floors and/or rooms within a building, or the like. In an embodiment, the particular points of interest available and/or visible to a user may depend on the selected level of detail (for example, the “zoom level”) for the digital wayfinding map. Nodes may be connected to other nodes through lines, for example, representing paths between the nodes. Lines are not limited to straight lines, but may include, without limitation, arcs, curves, paths, roadways, hallways, pedestrian walkways, waterways, stairs, escalators, elevators, and any other structure or form capable of connecting or representing a connection between nodes. A map application may be configured to generate navigable routes between nodes using the paths. For example, a map application may present a highlighted path on the map unit from a start node to a destination node within the map unit.

In general, a developer may use a map development application or map management application to generate a digital wayfinding map configured to be managed by a map application and/or a route generation application. The developer may create and/or access a map unit, such as an image file (for example, a .jpg, .bmp, .tiff, or the like) of a floor of a building or a geographical area, using the map development application. The developer may then position a node on each point of interest on the map unit so that a user may interact with the point of interest within the digital wayfinding map. For instance, a node object may be placed on the map unit at each point of interest, such as a street address on a geographical area map unit or a room in a building floor map unit.

Existing technology provides that the developer is required to separately place each individual node at each individual point of interest. As such, if a building digital wayfinding map includes fifty map units, one for each floor of the building, and thirty points of interest on each floor, then the developer is required to individually place a node for all fifteen hundred places of interest. After each node has been placed within the map unit, the developer is then required to individually connect each node. This generally requires creating a line between each node and any other node that may be reached therefrom. The number of points of interest greatly increases when paths between nodes and path intersections are also included. For example, in order to provide accurate directions, a node may be required to be placed where two paths intersect, such as at the intersection of two hallways on the floor of a building. As such, the creation of a digital wayfinding map using existing technology involves time-consuming and resource intensive processes that greatly affect the cost dynamics of each map project.

Accordingly, embodiments described herein provide for the efficient and cost-effective generation of digital wayfinding maps. In an embodiment, a map developer application may be configured to receive lines on a map unit and to automatically generate a node at each end of the line. The map developer application may be configured to receive lines that intersect other lines and to automatically generate nodes at each intersection point. Embodiments described herein may provide multiple technological advantages for digital wayfinding maps and for systems and methods for generating digital wayfinding maps. A non-limiting example of such an advantage is the more efficient and cost-effective creation of digital wayfinding maps as nodes and paths therebetween may be generated for a digital wayfinding map for points of interest and/or intersecting lines faster and more effectively than possible using existing technology.

Digital wayfinding maps configured according to embodiments are not limited to geographical areas or buildings, as any object capable of being represented through a routable map structure is contemplated herein, including, without limitation, electronic circuits, communication networks, social networks, supply chain networks, waterways, plumbing systems, electrical systems, and/or heating, ventilation, and air conditioning (HVAC) systems.

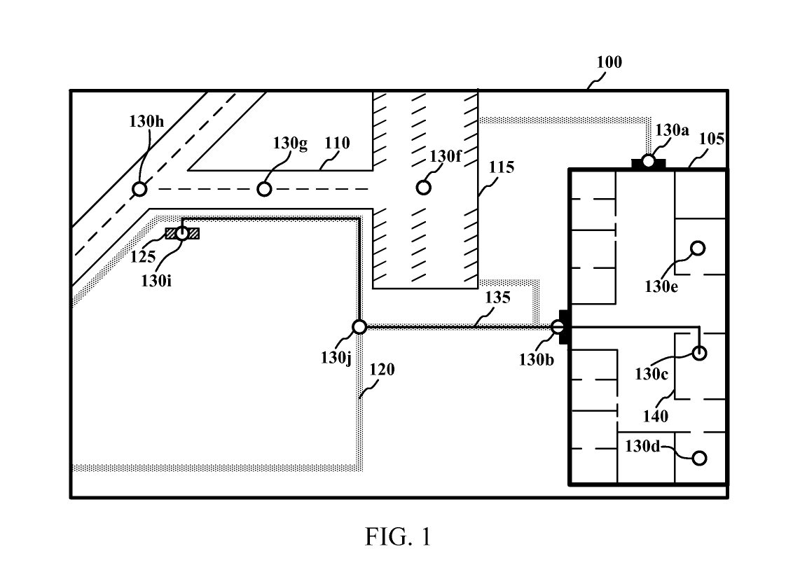

FIG. 1 depicts an illustrative digital wayfinding map according to some embodiments. As shown in FIG. 1, a digital wayfinding map 100 may include various graphical elements representing real-world objects within the area shown in the digital wayfinding map. Illustrative and non-restrictive graphical elements include a building 105, roads 110, a parking lot 115, a sidewalk 120, and a bus stop 125. Various nodes, or points of interest, may be designated on the digital wayfinding map, such as building entrances 130a, 130b, rooms within the building 130c-130e, the parking lot 130f, roads 130g, 130h, the bus stop 130i, and a sidewalk intersection 130j. A digital wayfinding map 100 configured according to some embodiments provided herein is not limited to the type and/or number of graphical elements and/or nodes described in association with FIG. 1, as those are for illustrative purposes only. Indeed, any type and/or number of graphical elements and/or nodes may be included in a digital wayfinding map 100.

The nodes 130a-130j may be configured to provide selectable and/or navigable points within the digital wayfinding map 100. For example, a node 130a-130j may be selected by a user to provide further information about the point of interest associated with the node, including, without limitation, names, addresses, latitude, longitude, distances from other nodes, or combinations thereof. According to some embodiments, a user may select nodes 130a-130j to receive directions for traveling between two or more nodes within the digital wayfinding map. For example, a user may be accessing the digital wayfinding map 100 using a logic device, such as a kiosk computing device, within room 140. The user may seek to find directions to the nearest bus stop 125 from their current location, designated on the digital wayfinding map 100 by node 130c. According to some embodiments, the map application may determine the nearest bus stop 125 or the user may select their current location, node 130c, and then select node 130h. The map application may generate the lowest-cost path 135 for the user to travel from their current location, node 130c, to their destination, node 130h.

In an embodiment, the map application may be configured to determine the lowest-cost path between all of the nodes 130a-130j using various path selection factors. Non-limiting examples of path selection factors for determining the lowest-cost path include time, distance, safety, popularity, environment, time of day, personal preferences, weather, or the like. For example, a user may prefer walking paths that are a combination of the shortest distance and proximity to main roadways. In another example, a walking path between two lecture halls on a college campus may be different in the wintertime, using more paths through connected buildings, as compared to the summertime. In an embodiment, the lowest-cost paths between the nodes may be determined based on an automated process, such as Djikstra's algorithm, to determine the shortest path between the nodes, including the nodes created at intersecting paths. In an embodiment, at least a portion of the path may be determined by the user. For example, the user may select three or more nodes on the digital wayfinding map and a path may be generated giving the user the lowest-cost path to travel to all of the selected nodes. In an embodiment, the lowest-cost paths may be determined based on a combination of path selection factors, an automated process, and/or a user selected portion of the path.

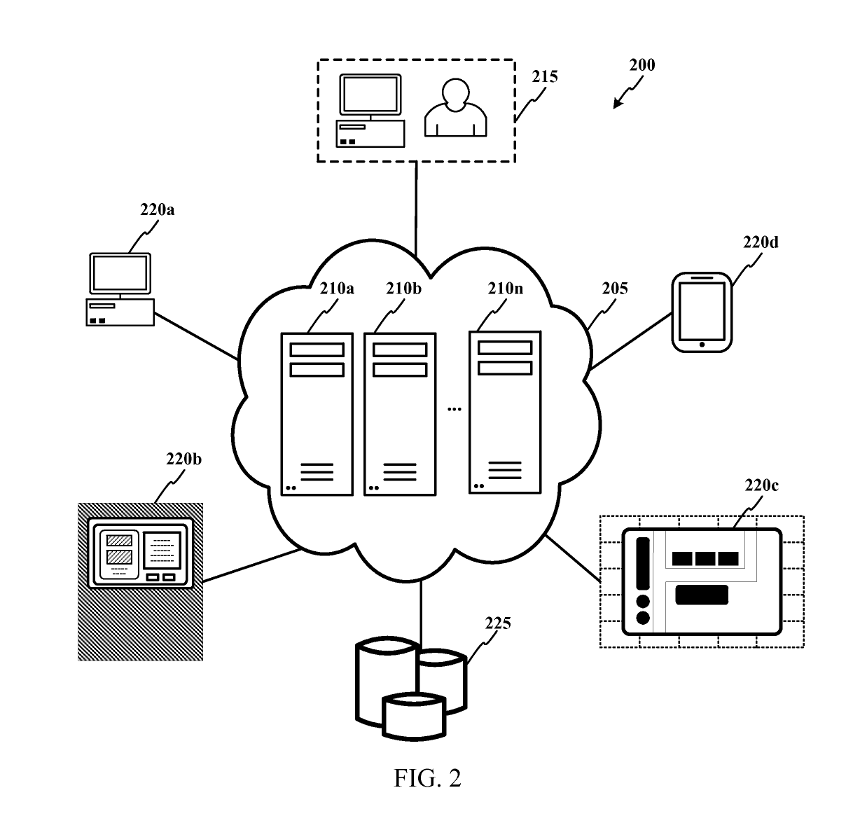

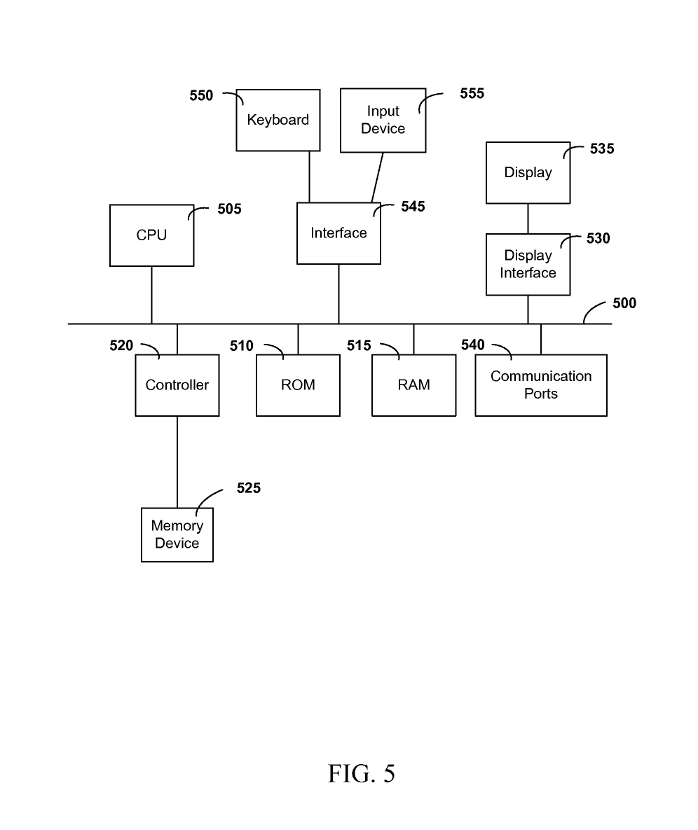

FIG. 2 depicts a digital wayfinding map system according to some embodiments. As shown in FIG. 2, a digital wayfinding map system 200 may include one or more computing devices 210a-210n, which may generally include a processor, a non-transitory memory or other storage device for housing programming instructions, data or information regarding one or more applications, and other hardware, including, for example, the central processing unit (CPU) 505, read only memory (ROM) 510, random access memory (RAM) 515, communication ports 540, controller 520, and/or memory device 525 depicted in FIG. 5 and described below in reference thereto. In an embodiment, the programming instructions may include a map application configured to present a digital wayfinding map on a display component in operable communication with a logic device, including, but not limited to, a server computing device 210a-210n, a personal computer (PC) 220a, a kiosk computing device 220b, a wall-mounted computing device 220c, a mobile computing device 220d, such as a laptop computer, smartphone, personal digital assistant (PDA), tablet computing device, or any other logic and/or computing device now known or developed in the future. For example, the map application may be configured to provide visitors with directions to points of interest within a building using a digital wayfinding map presented on kiosk computing devices 220b and/or wall-mounted computing devices 220c positioned at various locations throughout the building. In another example, a user may access a digital wayfinding map for a geographical region using a smartphone mobile computing device 220d to determine the lowest-cost route to travel between locations within the geographical region.

In some embodiments, the map application may be accessible through various platforms, such as a client application, web-based application, over the Internet, and/or a mobile application (for example, a “mobile app” or “app”). According to some embodiments, the map application may be configured to operate on each logic device 210a-210n, 220a-220d and/or to operate on a server computing device accessible to logic devices over a network 205, such as the Internet. All or some of the files, data and/or processes (for example, route generating processes) associated with each digital wayfinding map may be stored locally on each logic device 210a-210n, 220a-220d and/or stored in a central location and accessible over a network 205.

In an embodiment, one or more data stores 225 may be accessible by the logic devices 210a-210n, 220a-220d for the generation and/or presentation of the digital wayfinding maps. For example, the one or more data stores 225 may include, without limitation, images, node data, path data, network data, device data, user profile data, and/or metadata associated therewith. In another example, the one or more data stores 225 may include third-party data sources that may be used to generate a digital wayfinding map and/or routes between nodes presented on the digital wayfinding map. For instance, a third-party data source may include blueprint images for a building, information to present to a user responsive to selection of a node, such as a hyperlink associated with a business having an address associated with a particular node, or the like. The one or more data stores 225 may include various information resources. Illustrative and non-restrictive examples include databases, digital files, such as digital documents (for example, image files, maps, blueprints, or the like), websites, multimedia files, audio files, video files, or the like. Accordingly, embodiments are not limited to any particular form of information resource as any form in existence or developed in the future capable of operating according to embodiments is contemplated herein.

Although the one or more data stores 225 are depicted as being separate from the logic devices 210a-210n, 220a-220d, embodiments are not so limited, as all or some of the one or more data stores may be stored in one or more of the logic devices.

In an embodiment, a map development application 215 may be provided to generate the digital wayfinding maps, the map application, map data, and/or map images. The map development application 215 may be executed on a logic device, such as logic devices 210a-210n, 220a-220d. In an embodiment, the map development application 215 may be configured to generate and/or update a digital wayfinding map and to provide access to the new and/or updated digital wayfinding map to logic devices 210a-210n, 220a-220d within the system 200. According to some embodiments, the map development application 215 may be a module of the map application, and vice versa. The map development application 215 may include various modules, tools, or the like for generating digital wayfinding maps. For instance, the map development application 215 may include modules configured to access image files, create map units, add structures, add geographical areas, add lines (for example, paths, elevators, stairs, escalators), generate routes, test routes, add points of interest, and add information related thereto.

According to some embodiments, a route generation application or module may operate on one or more of the logic devices 210a-210n, 220a-220d within the system 200. The route generation module may be configured to generate routes based on information obtained from the map development application 215 and/or the one or more data stores 225. For instance, the route generation application may generate a route and/or obtain an existing route in response to a request from the map application operating on one or more of the logic devices 210a-210n, 220a-220d. According to some embodiments, routes between nodes may be generated by the map development application and/or route generation application and saved, for instance, in the one or more data stores 225. Responsive to a request to generate a route between nodes, the map development application 215 and/or the route generation application may determine whether a route between the nodes already exists. The existing route may be used as the generated route such that the route does not need to be re-generated. The map development application 215 and/or the route generation application may determine whether changes along the route have occurred and may modify the route to incorporate the changes (for instance, the addition/removal of a node).

In an embodiment, the route generation application may operate on a server computing device 210a-210n and may be accessed by the map application through one or more interfaces, such as an application programming interfaces (APIs). In an embodiment, the route generation application may be a standalone software application operating between the map application and the map development application. For instance, the route generation application may receive requests from the map application to generate a route and the route generation application may communicate with the map development application to obtain information associated with generating the requested route. In an embodiment, the route generation application may be a module of the map application and/or the map development application.

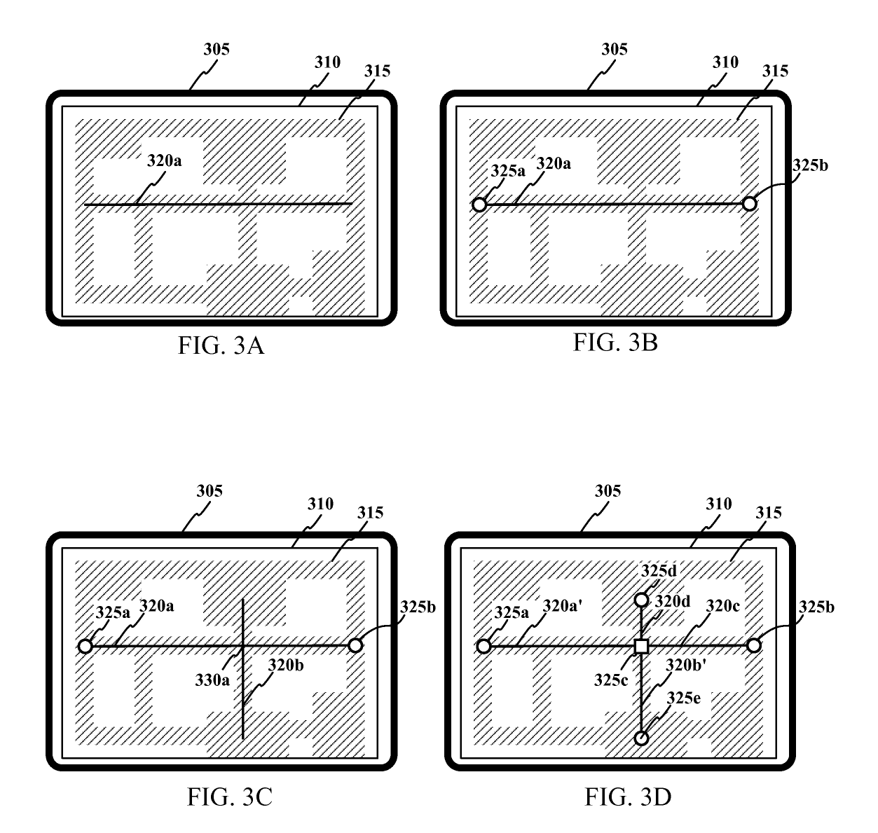

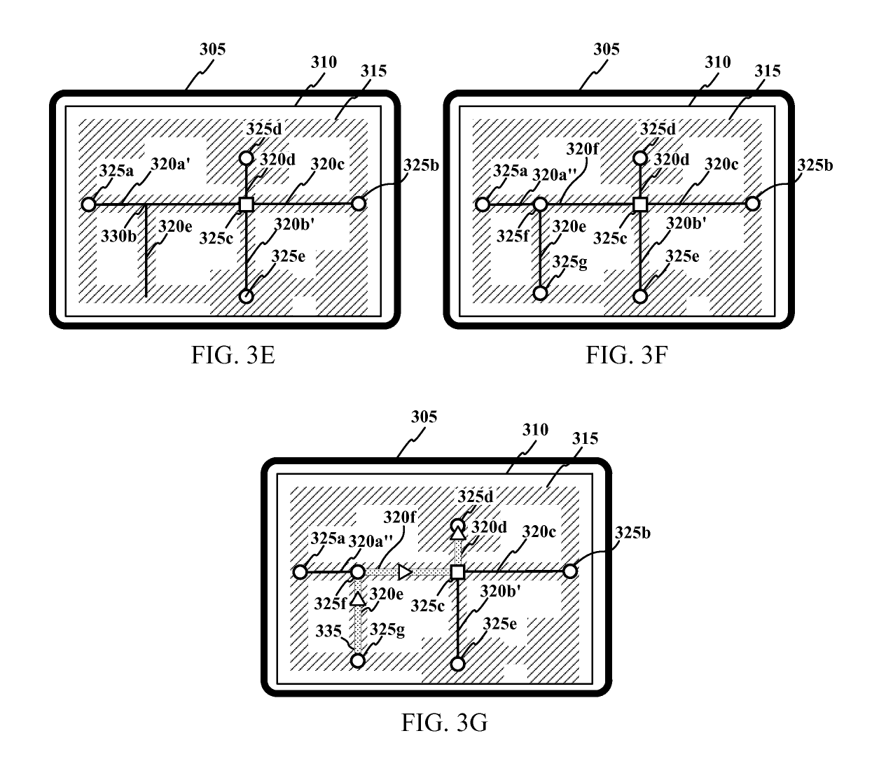

FIGS. 3A-3G depict an illustrative example of generating a portion of a digital wayfinding map according to some embodiments. As shown in FIG. 3A, a map unit 310 of a digital wayfinding map may be presented on a display component 305. For example, the map unit 310 may presented through a map development application 215 as depicted in FIG. 2. In the example depicted in FIG. 3A, the map unit 310 may represent a floor in a building for an indoor digital wayfinding map. The graphical representation of the map unit 310 may be configured to indicate open areas 315 on the floor where a building visitor may walk, such as rooms and hallways.

A developer may generate (or “draw”) a first line 320a on the map unit, for example, representing a path through a hallway. Referring now to FIG. 3B, the map development application 215 may be configured to automatically generate nodes 325a, 325b on each end of the first line 320a. As such, the developer has created three elements, namely, nodes 325a and 325b and first line 320a connecting said nodes on the map unit 310 through one event, the drawing of the first line. The creation of nodes 325a, 325b and first line 320a connecting said nodes using existing technology would require at least the following three separate events: the creation of node 325a, the creation of node 325b and the creation of the first line 320a connecting said nodes.

As shown in FIG. 3C, the map development application 215 may receive a second line 320b on the map unit, for example, connecting two rooms within the floor through a hallway. Referring now to FIG. 3D, the map development application 215 may automatically generate nodes 325d, 325e at the ends of the second line 320b. The second line 320b intersects the first line 320a at an intersection point 330a. The map development application 215 may automatically generate node 325c at the intersection of the first line 320a and the second line 320b. The generation of nodes at the intersection points of lines within a map unit facilitates, among other things, the creation of routes using the intersection points. For instance, without node 325c, a route from node 325a to node 325e using the map unit 310 depicted in FIG. 3D would not be possible without the creation of more lines and/or nodes. However, the lowest-cost route from node 325a to node 325e using the map unit 310 depicted in FIG. 3D involves traveling from node 325a to node 325c and then to node 325e.

According to some embodiments, the map development application 215 may divide intersecting lines to generate new lines responsive to the generation of nodes. For example, the first line 320a and the second line 320b may be divided based on node 325c. The map development application 215 may automatically divide the first line 320a into a first line 320a′ and a third line 320c, and the second line 320b into a second line 320b′ and a fourth line 320d. In this manner, the map development application 215 may generate separate lines such that one line connects two nodes, for example, for route generation responsive to the addition of nodes. For instance, the map development application 215 may be capable of generating a route from node 325b to 325d through a path created by lines 320c and 320d, which were created through the division of the first line 320a and the second line 320b.

The creation of the map unit 310 depicted in FIG. 3D using existing technology may have required at least nine separate events, including creating the five nodes 325a-325e and the four lines 320a′-320d connecting the five nodes. However, the creation of the map unit 310 depicted in FIG. 3D using a map development application 215 configured according to embodiments described herein may require only two events. For instance, receiving the first line 320a and receiving the intersecting second line 320b, as depicted in FIG. 3C. In this manner, digital wayfinding maps may be created using a map development application 215 configured according to embodiments in a more efficient and cost-effective manner when compared to systems and methods available using existing technology.

FIGS. 3E and 3F depict the creation of a “T” or “cross” intersection. As shown in FIG. 3E, the map development application 215 may receive a fifth line 320e, which is the third line received by the map development application. The fifth line 320e may intersect the first line 320a′ at intersection point 330b. Referring now to FIG. 3F, the map development application 215 may be configured to generate a node 325f at intersection point 330b and a node 325g at the end of the fifth line 320e opposite the intersection point. In addition, map development application 215 may divide the first line 320a′ into a first line 320a″ and a sixth line 320f. As shown in FIG. 3F, thirteen objects, including six lines 320a″-320f and seven nodes 325a-325g, may be generated using a map development application 215 configured according to some embodiments through only the following three events: receiving the first line 320a, receiving the second line 320b and receiving the fifth line 320e. Accordingly, embodiments provide that all of the nodes and paths between the nodes may be generated by a developer by drawing lines representing paths between points of interest of a digital wayfinding map. A typical digital wayfinding map project may include many thousands of nodes and paths therebetween. As such, embodiments may provide a substantial reduction in the amount of time, effort and cost necessary to create a digital wayfinding map. For example, a digital wayfinding map for a mid-sized university may require three to four months to create using conventional technology, while the same map may only require about two to three weeks to create using embodiments described herein.

The map development application 215 may be configured to update the population of lines 320a″-320f, nodes 325a-325g, map units 310, and/or routes 335 therebetween responsive to the removal of a line, node and/or map unit. For instance, a node 325a-325g may become unavailable, effecting routes that include the particular node. The map development application 215 may be configured to re-generate the routes 335 for the digital wayfinding map such that they avoid using the unavailable node 325a-325g.

Embodiments provide that the map development application may generate routes between nodes 325a-325g in a map unit 310 and/or between nodes in different map units. All possible routes may be generated after all of the lines 320a″-320f and nodes 325a-325g have been generated for the map unit 310. As described above, the routes may be generated using various processes and/or factors. In an embodiment, at least a portion of the map units 310, lines 320a″-320f and/or nodes 325a-325g associated with a digital wayfinding map may be stored in one or more data storage components, including, without limitation, an electronic file (for example, a spreadsheet, an extensible markup language (XML) file), a database, or combinations thereof. The map development application 215 may use the map units 310, lines 320a″-320f, nodes 325a-325g, and/or information associated therewith to generate routes between nodes. FIG. 3G depicts an illustrative route 335 between node 325g to node 325d on map unit 310 in a direction indicated by the arrows on the route.

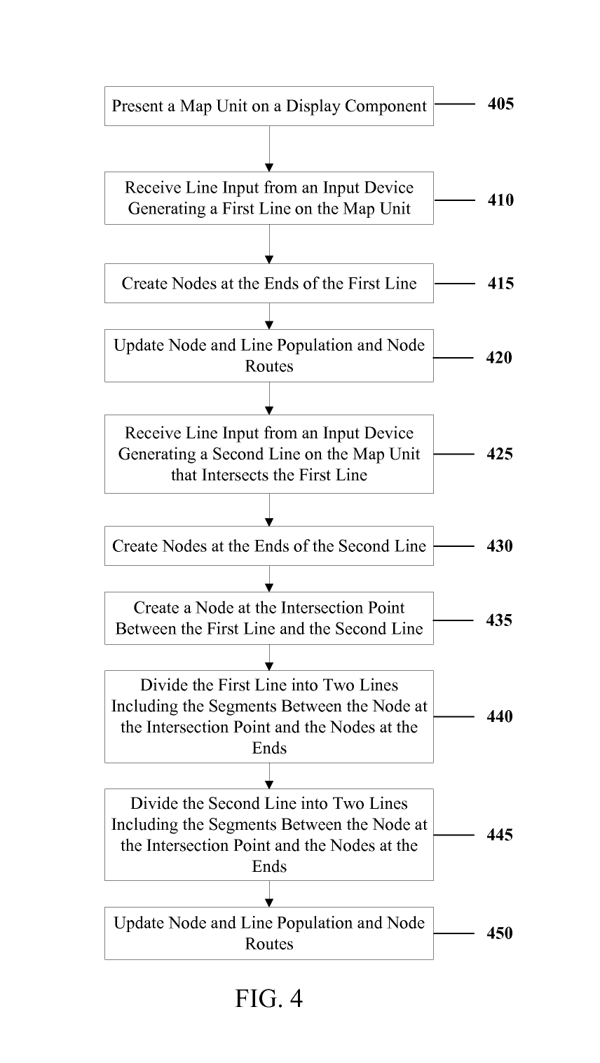

FIG. 4 depicts a flow diagram for an illustrative method for generating a digital wayfinding map according to some embodiments. A map unit may be presented 405 on a display component. For instance, a map development application may be configured to present 405 a map unit to a developer on a display component in operable communication with a logic device executing the map development application. In this manner, the developer may view and update the map unit to generate a digital wayfinding map.

The map development application may receive 410 line input from an input device generating a first line on the map unit. For example, the developer may “draw” a line on the map unit using a mouse input device. The map development application may create 415 nodes at the ends of the first line. The map development application may update 420 the population of nodes and lines and the routes between the population of nodes. For example, the map development application may access a data storage element, such as an XML file, for storing each node and line and information associated therewith, such as the position and relationship of each node and line. The set of routes between each node using the lines may be updated responsive to receiving 410 the line and creating 415 the nodes at the end of the line.

The map development application may receive 425 line input from an input device generating a second line on the map unit that intersects the first line. The map development application may create 430 nodes at the ends of the second line and may create 435 a node at the intersection point between the first line and the second line. The first line may be divided 440 into two lines that include the segments between the node at the intersection point and the nodes at the ends. The second line may also be divided 445 into two lines that include the segments between the node at the intersection point and the nodes at the ends. The map development application may update 450 the population of nodes and lines and the routes between the population of nodes.

FIG. 5 depicts a block diagram of exemplary internal hardware that may be used to contain or implement the various computer processes and systems as discussed above. A bus 500 serves as the main information highway interconnecting the other illustrated components of the hardware. CPU 505 is the central processing unit of the system, performing calculations and logic operations required to execute a program. CPU 505, alone or in conjunction with one or more of the other elements disclosed in FIG. 5, is an exemplary processing device, computing device or processor as such terms are used within this disclosure. Read only memory (ROM) 530 and random access memory (RAM) 535 constitute exemplary memory devices.

A controller 520 interfaces with one or more optional memory devices 525 to the system bus 500. These memory devices 525 may include, for example, an external or internal DVD drive, a CD ROM drive, a hard drive, flash memory, a USB drive or the like. As indicated previously, these various drives and controllers are optional devices. Additionally, the memory devices 525 may be configured to include individual files for storing any software modules or instructions, auxiliary data, common files for storing groups of results or auxiliary, or one or more databases for storing the result information, auxiliary data, and related information as discussed above. For example, the memory devices 525 may be configured to store information associated with the one or more data stores 225.

Program instructions, software or interactive modules for performing any of the functional steps associated with the analysis of judicial decision making as described above may be stored in the ROM 530 and/or the RAM 535. Optionally, the program instructions may be stored on a tangible computer-readable medium such as a compact disk, a digital disk, flash memory, a memory card, a USB drive, an optical disc storage medium, such as a Blu-ray™ disc, and/or other recording medium.

An optional display interface 530 may permit information from the bus 500 to be displayed on the display 535 in audio, visual, graphic or alphanumeric format. The information may include information related to a current job ticket and associated tasks. Communication with external devices may occur using various communication ports 540. An exemplary communication port 540 may be attached to a communications network, such as the Internet or a local area network.

The hardware may also include an interface 545 which allows for receipt of data from input devices such as a keyboard 550 or other input device 555 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by the following claims.

What is claimed is:

1. A system for generating routes for a digital wayfinding map, the system comprising:
a processor; and
a non-transitory, computer-readable storage medium in operable communication with the processor, wherein the computer-readable storage medium contains one or more programming instructions that, when executed, cause the processor to:
receive a plurality of lines arranged on a map unit of the digital wayfinding map, each of the plurality of lines comprising a first end and a second end;
generate a plurality of nodes on the map unit responsive to receiving each of the plurality of lines, the plurality of lines forming paths between the plurality of nodes; and
position the plurality of nodes at the first end, the second end, and at least one intersection point created responsive to intersection of the plurality of lines.

2. The system of claim 1, wherein the computer-readable storage medium further contains one or more programming instructions that, when executed, cause the processor to generate the routes for the wayfinding digital map based on lowest-cost paths between the plurality of nodes.

3. The system of claim 1, wherein the computer-readable storage medium further contains one or more programming instructions that, when executed, cause the processor to divide each of the plurality of lines such that one individual line connects two nodes.

4. The system of claim 1, wherein at least a portion of the plurality of nodes represent points of interest within the digital wayfinding map.

5. The system of claim 1, wherein at least a portion of the digital wayfinding map is configured to represent a building.

6. The system of claim 5, wherein the map unit is configured to represent at least one floor of the building.

7. The system of claim 5, wherein at least a portion of the plurality of nodes is configured to represent rooms in the building.

8. The system of claim 1, further comprising a display component operatively coupled to the processor,
wherein the computer-readable storage medium further contains one or more programming instructions that, when executed, cause the processor to present the digital wayfinding map on the display component.

9. A computer-implemented method for generating routes for a digital wayfinding map, the method comprising, by a processor:
receiving a plurality of lines arranged on a map unit of the digital wayfinding map, the plurality of lines comprising a first end and a second end;
generating a plurality of nodes on the map unit responsive to receiving each of the plurality of lines, the plurality of lines forming paths between the plurality of nodes; and
positioning the plurality of nodes at the first end, the second end, and at least one intersection point created responsive to intersection of the plurality of lines.

10. The method of claim 9, further comprising generating the routes for the wayfinding digital map based on lowest-cost paths between the plurality of nodes.

11. The method of claim 9, further comprising dividing each of the plurality of lines such that one individual line connects two nodes.

12. The method of claim 9, wherein at least a portion of the plurality of nodes represent points of interest within the digital wayfinding map.

13. The method of claim 9, wherein at least a portion of the digital wayfinding map is configured to represent a building.

14. The method of claim 13, wherein the map unit is configured to represent at least one floor of the building.

15. The method of claim 13, wherein at least a portion of the plurality of nodes is configured to represent rooms in the building.

16. The method of claim 9, further comprising presenting the digital wayfinding map on a display component operatively coupled to the processor.

17. A computer-readable storage medium having computer-readable program code configured to generate routes for a digital wayfinding map embodied therewith, the computer-readable program code comprising:
computer-readable program code configured to receive a plurality of lines arranged on a map unit of the digital wayfinding map, the plurality of lines comprising a first end and a second end;
computer-readable program code configured to generate a plurality of nodes on the map unit responsive to receiving each of the plurality of lines, the plurality of lines forming paths between the plurality of nodes;
computer-readable program code configured to position the plurality of nodes at the first end, the second end, and at least one intersection point created responsive to intersection of the plurality of lines.

18. The computer-readable storage medium of claim 17, further comprising computer readable program code configured to generate the routes for the wayfinding digital map based on lowest-cost paths between the plurality of nodes.

19. The computer-readable storage medium of claim 17, further comprising computer readable program code configured to divide each of the plurality of lines such that one individual line connects two nodes.

20. The computer-readable storage medium of claim 17, further comprising computer readable program code configured to present the digital wayfinding map on a display component.
